(19) United States
(12) Patent Application Publication
(10) Pub. No.: US 2026/0003024 A1
(43) Pub. Date: Jan. 1, 2026

(54) METHODS, SYSTEMS, AND COMPUTER READABLE MEDIA FOR TESTING BROADCAST POSITIONING SYSTEM (BPS) DEVICES

(71) Applicant: Keysight Technologies, Inc., Santa Rosa, CA (US)

(72) Inventor: Stephen Samuel Jackson, Chapel Hill, NC (US)

(21) Appl. No.: 19/255,096

(22) Filed: Jun. 30, 2025

Related U.S. Application Data
(60) Provisional application No. 63/666,644, filed on Jul. 1, 2024.

(51) Int. Cl. G01S 5/02; H04B 17/00; H04B 17/11

(52) U.S. Cl. CPC G01S 5/021; H04B 17/11; H04B 17/0085

(57) ABSTRACT

A method for testing a broadcast positioning system (BPS) device includes transmitting, using a BPS test system, a signal to a BPS device under test (DUT), the signal including BPS timing information. The method further includes receiving, by the BPS test system, from the BPS DUT and responsive to the transmitted signal, a signal including timing information. The method further includes reading, from the signal transmitted by the BPS DUT, the timing information. The method further includes using the timing information extracted from the signal transmitted by the BPS DUT to evaluate functionality or performance of the BPS DUT.

### PRIORITY CLAIM

This application claims the priority benefit of U.S. Provisional Patent Application Serial No. 63/666,644 filed July 1, 2024, the disclosure of which is incorporated herein by reference in its entirety.

### TECHNICAL FIELD

The subject matter described herein relates to broadcast positioning systems. More particularly, the subject matter described herein relates to methods, systems, and computer readable media for testing BPS devices.

### BACKGROUND

There are many sources of location and timing information for devices capable of electronic communications. However, current sources of location and timing information have one or more drawbacks. Once source of location and timing information is the global positioning system (GPS). GPS relies on a network of geosynchronous satellites to provide location and timing information to GPS receivers. One drawback of using GPS is the dependency on an array of low powered satellite signals, limiting coverage. In addition, GPS signals are vulnerable to being disabled, jammed, or spoofed. They can otherwise fail completely."

Another source of location and timing information to connected devices is the cellular communications system. Cellular communications require a signal from an antenna located at a cellular base station. Due to the frequencies typically used for cellular communications, a cellular communications receiver must be within the line of sight of base station antenna to receive signals from the base station. Using the cellular communications system as a source of location and timing information can have some of the same problems as GPS, such as lack of coverage in some areas. In addition, due to the high volume of cellular communications system users, base station processing resources can become overwhelmed and unable to provide location and timing information to connected devices in real time.

Yet another source of location and timing information is the broadcast positioning system or BPS. The broadcast positioning system is a network of television broadcast stations that can be used to provide location and timing information to connected devices. The broadcast positioning system can operate as an independent source of location and timing information, for example, to supplement other sources or when GPS, cellular networks, and/or the Internet are not available. However, the broadcast positioning system, similar to other sources of location and timing information, needs to be tested to ensure its functionality and reliability.

Accordingly, in light of these and other difficulties, there exists a need for improved methods, systems, and computer readable media for testing broadcast positioning system devices, such as BPS transmitters and BPS receivers.

### SUMMARY

A method for testing a broadcast positioning system (BPS) device includes transmitting, using a BPS test system, a signal to a BPS device under test (DUT), the signal including BPS timing information. The method further includes receiving, by the BPS test system, from the BPS DUT and responsive to the transmitted signal, a signal including timing information. The method further includes reading, from the signal transmitted by the BPS DUT, the timing information. The method further includes using the timing information extracted from the signal transmitted by the BPS DUT to evaluate functionality or performance of the BPS DUT.

According to another aspect of the subject matter described herein, transmitting the signal to the BPS DUT includes transmitting a reference clock signal to a BPS transmitter DUT, receiving the signal from the BPS DUT includes receiving an advanced television systems committee (ATSC) signal from the BPS transmitter DUT, and using the timing information to evaluate functionality or performance of the BPS DUT includes comparing the timing information extracted from the signal transmitted by the BPS transmitter DUT to the reference clock signal.

According to another aspect of the subject matter described herein, transmitting the signal to the BPS DUT includes transmitting an advanced television systems committee (ATSC) signal to a BPS transmitter DUT configured to operate as an ATSC timing relay, receiving the signal from the BPS transmitter DUT configured to operate as the ATSC timing relay includes receiving an ATSC signal from the BPS transmitter DUT configured to operate as the ATSC timing relay, using the timing information to evaluate functionality or performance of the BPS DUT includes comparing the timing information extracted from the ATSC signal transmitted by the BPS transmitter DUT configured to operate as the BPS timing relay to the timing information in the ATSC signal transmitted to the BPS transmitter DUT configured to operate as the ATSC timing relay.

According to another aspect of the subject matter described herein, transmitting the signal to the BPS DUT includes transmitting an advanced television systems committee (ATSC) signal to a BPS transmitter DUT configured to operate as an ATSC timing transcoder, receiving the signal from the BPS transmitter DUT configured to operate as the ATSC timing transcoder includes receiving a non-ATSC signal from the BPS transmitter DUT configured to operate as the ATSC timing transcoder, and using the timing information to evaluate functionality or performance of the BPS DUT includes comparing the timing information extracted from the non-ATSC signal transmitted by the BPS transmitter DUT configured to operate as the ATSC timing transcoder to the timing information in the ATSC signal transmitted to the BPS transmitter DUT configured to operate as the ATSC timing transcoder.

According to another aspect of the subject matter described herein, receiving the non-ATSC signal includes receiving a precision time protocol (PTP) signal.

According to another aspect of the subject matter described herein, transmitting the signal to the BPS DUT includes transmitting a plurality of signals to the BPS DUT using a plurality of parallel combinations of frame generators and transmit signal chains.

According to another aspect of the subject matter described herein, transmitting the signal to the BPS DUT includes transmitting N output signals to the BPS DUT using a multiplexer that multiplexes M signals to produce the N output signals for transmission to the BPS DUT via a transmit signal chain implemented by a software defined radio (SDR), wherein M and N are integers and M is greater than N.

According to another aspect of the subject matter described herein, transmitting the signal to the BPS DUT includes transmitting a reference clock signal to a BPS receiver DUT, receiving the signal from the BPS DUT includes receiving an advanced television systems committee (ATSC) signal from the BPS receiver DUT, and using the timing information to evaluate functionality or performance of the BPS DUT includes comparing the timing information extracted from the signal transmitted by the BPS receiver DUT to the reference clock signal.

According to another aspect of the subject matter described herein, transmitting the signal to the BPS DUT includes transmitting an advanced television systems committee (ATSC) signal to a BPS receiver DUT configured to operate as an ATSC timing transcoder and a timing information source, receiving the signal from the BPS receiver DUT configured to operate as the ATSC timing transcoder and the timing information source includes receiving a non-ATSC signal from the BPS receiver configured to operate as the ATSC timing transcoder and the timing information source, and using the timing information to evaluate functionality or performance of the BPS DUT includes comparing the timing information extracted from the non-ATSC signal transmitted by the BPS transmitter DUT configured to operate as the ATSC timing transcoder and the timing information source to a reference clock.

According to another aspect of the subject matter described herein, the BPS receiver configured to operate as the ATSC timing transcoder, and the timing information source includes a BPS receiver configured to operate as an ATSC-to- precision time protocol (PTP) timing transcoder and PTP grandmaster.

According to another aspect of the subject matter described herein, a system for testing a broadcast positioning system (BPS) device is provided. The system includes a BPS test system including at least one processor and a memory. Ther system further includers at least one emulator implemented by the at least one processor for transmitting, using a BPS test system, a signal to a BPS device under test (DUT), the signal including BPS timing information, receiving, by the BPS test system, from the BPS DUT and responsive to the transmitted signal, a signal including timing information, reading, from the signal transmitted by the BPS DUT, the timing information. The system further includes a performance analyzer implemented by the at least one processor for using the timing information extracted from the signal transmitted by the BPS DUT to evaluate functionality or performance of the BPS DUT.

According to another aspect of the subject matter described herein, the signal transmitted to the BPS DUT comprises a reference clock signal, the BPS DUT comprises a BPS transmitter DUT, the signal received from the BPS DUT comprises an advanced television systems committee (ATSC) signal from the BPS transmitter DUT, and the performance analyzer is configured to use the timing information to evaluate functionality or performance of the BPS DUT by comparing the timing information extracted from the signal transmitted by the BPS transmitter DUT to the reference clock signal.

According to another aspect of the subject matter described herein, the signal transmitted to the BPS DUT comprises an advanced television systems committee (ATSC) signal, the BPS DUT comprises a BPS transmitter DUT configured to operate as an ATSC timing relay, the signal received from the BPS DUT comprises an ATSC signal from the BPS transmitter DUT configured to operate as the ATSC timing relay, and the performance analyzer is configured to use the timing information to evaluate functionality or performance of the BPS DUT by comparing the timing information read from the ATSC signal transmitted by the BPS transmitter DUT configured to operate as the BPS timing relay to the timing information in the ATSC signal transmitted to the BPS transmitter DUT configured to operate as the ATSC timing relay.

According to another aspect of the subject matter described herein, the signal transmitted to the BPS DUT comprises an advanced television systems committee (ATSC) signal, the BPS DUT comprises a BPS transmitter DUT configured to operate as an ATSC timing transcoder, the signal received from the BPS transmitter DUT configured to operate as the ATSC timing transcoder comprises a non-ATSC signal, and the performance analyzer is configured to use the timing information to evaluate functionality or performance of the BPS DUT by comparing the timing information read from the non-ATSC signal transmitted by the BPS transmitter DUT configured to operate as the ATSC timing transcoder to the timing information in the ATSC signal transmitted to the BPS transmitter DUT configured to operate as the ATSC timing transcoder.

According to another aspect of the subject matter described herein, the non-ATSC signal comprises a precision time protocol (PTP) signal.

According to another aspect of the subject matter described herein, the system for testing BPS devices includes a plurality of parallel combinations of frame generators and transmit signal chains for transmitting a plurality of signals to the BPS DUT.

According to another aspect of the subject matter described herein, the system for testing BPS devices includes a multiplexer configured to multiplex M input signals to N output signals for transmission to the BPS DUT, where M and N are integers and M is greater than M, and a transmit signal chain implemented by a software defined radio (SDR) for receiving the N output signals and transmitting the N output signals to the BPS DUT.

According to another aspect of the subject matter described herein, the signal transmitted to the BPS DUT comprises a reference clock signal, the BPS DUT comprises a BPS receiver DUT, the signal from the BPS DUT comprises an advanced television systems committee (ATSC) signal, and the performance analyzer is configured to use the timing information to evaluate functionality or performance of the BPS DUT by comparing the timing information extracted from the signal transmitted by the BPS receiver DUT to the reference clock signal.

According to another aspect of the subject matter described herein, the signal transmitted to the BPS DUT includes an advanced television systems committee (ATSC) signal, the BPS DUT comprises a BPS receiver DUT configured to operate as an ATSC timing transcoder and a timing information source, the signal received from the BPS receiver DUT configured to operate as the ATSC timing transcoder and the timing information source comprises a non- ATSC signal, and the performance analyzer is configured to use the timing information to evaluate functionality or performance of the BPS DUT by comparing the timing information extracted from the non-ATSC signal transmitted by the BPS transmitter DUT configured to operate as the ATSC timing transcoder and the timing information source to a reference clock.

According to another aspect of the subject matter described herein, a non- transitory computer readable medium having stored thereon executable instructions that when executed by a processor of a computer control the computer to perform steps is provided. The steps include transmitting, using a broadcast positioning system (BPS) test system, a signal to a BPS device under test (DUT), the signal including BPS timing information. The steps further include receiving, by the BPS test system, from the BPS DUT and responsive to the transmitted signal, a signal including timing information. The steps further include reading, from the signal transmitted by the BPS DUT, the timing information. The steps further include using the timing information extracted from the signal transmitted by the BPS DUT to evaluate functionality or performance of the BPS DUT.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

### Exemplary implementations of the subject matter described herein will now be explained with reference to the accompanying drawings, of which:

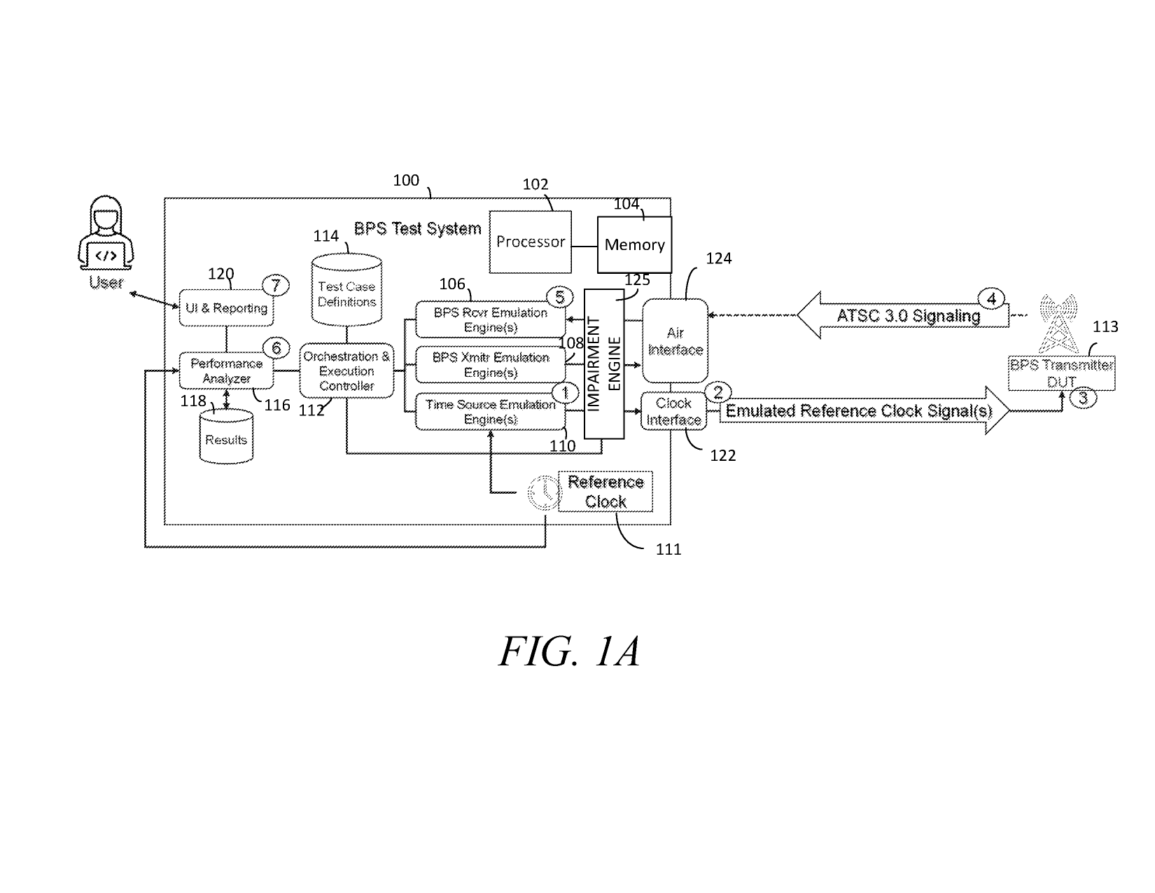

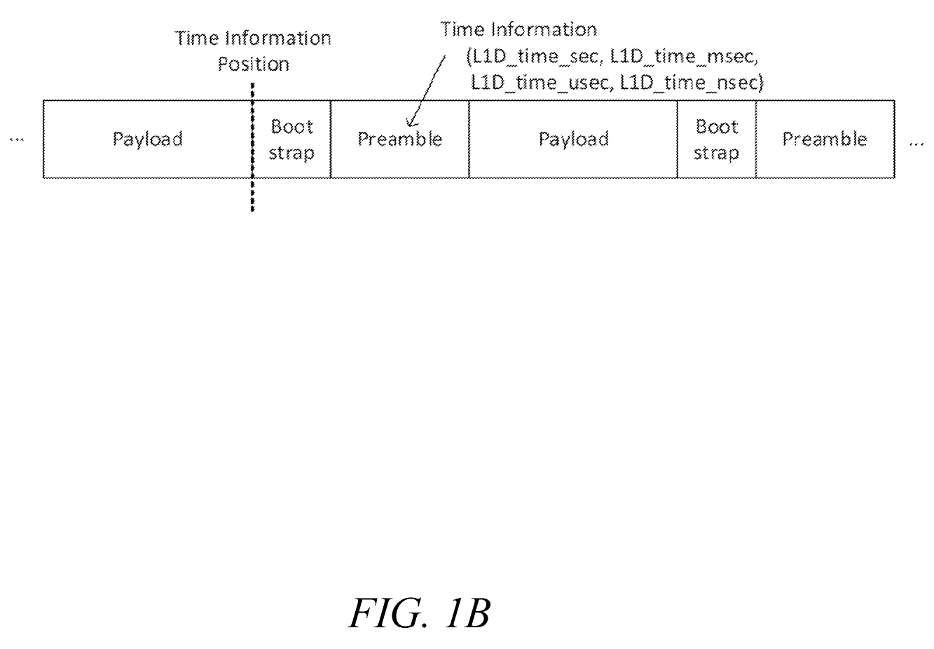

FIG. 1A is a block diagram illustrating an example architecture for a BPS test system capable of performing reference clock testing, BPS receiver emulation, BPS transmitter emulation, and time source emulation;

FIG. 1 B illustrates an example of parameters that may be included in an ATSC 3.0 signal;

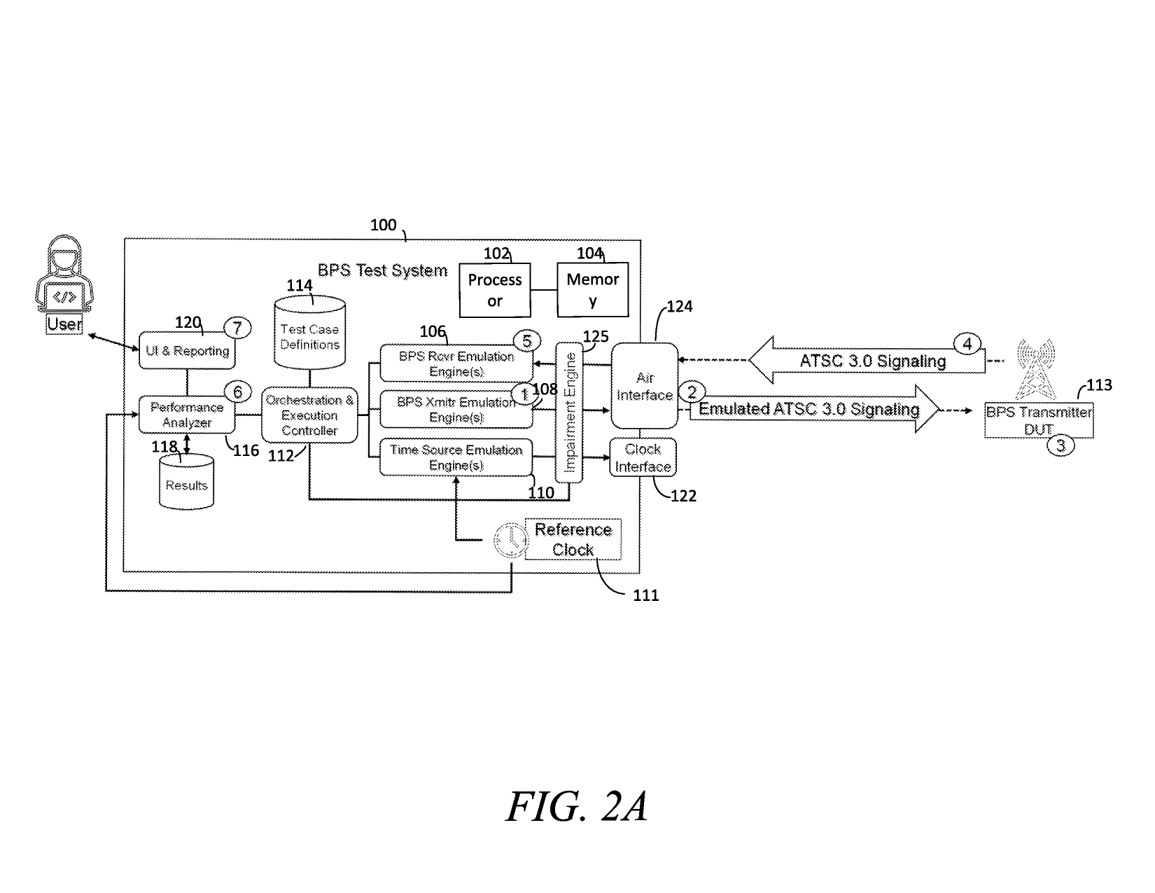

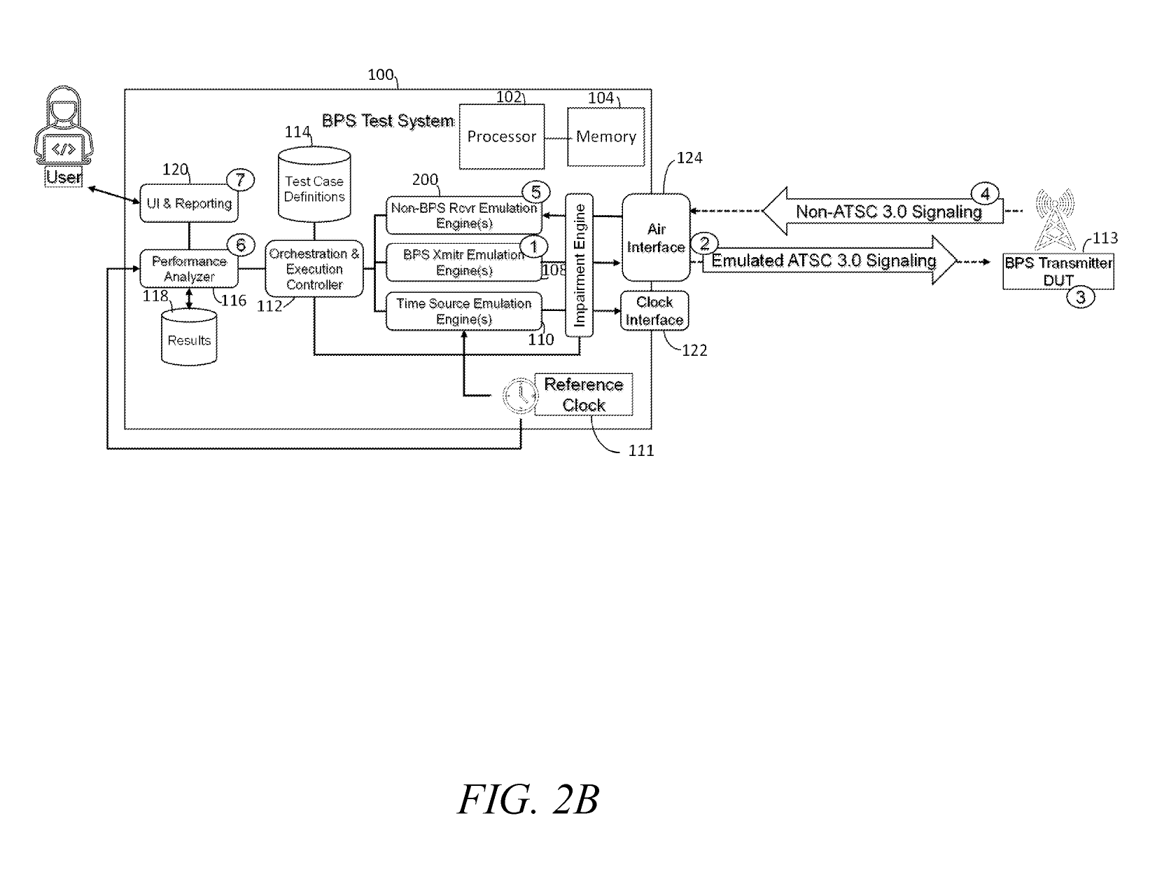

FIG. 2A is a block diagram of a BPS test system and a BPS transmitter DUT operating as a BPS timing relay illustrating exemplary steps performed by the BPS test system in testing the BPS transmitter DUT operating as a BPS timing relay;

FIG. 2B is a block diagram of a BPS test system and a transcoding BPS transmitter illustrating exemplary steps performed by the BPS test system in testing the transcoding BPS transmitter DUT;

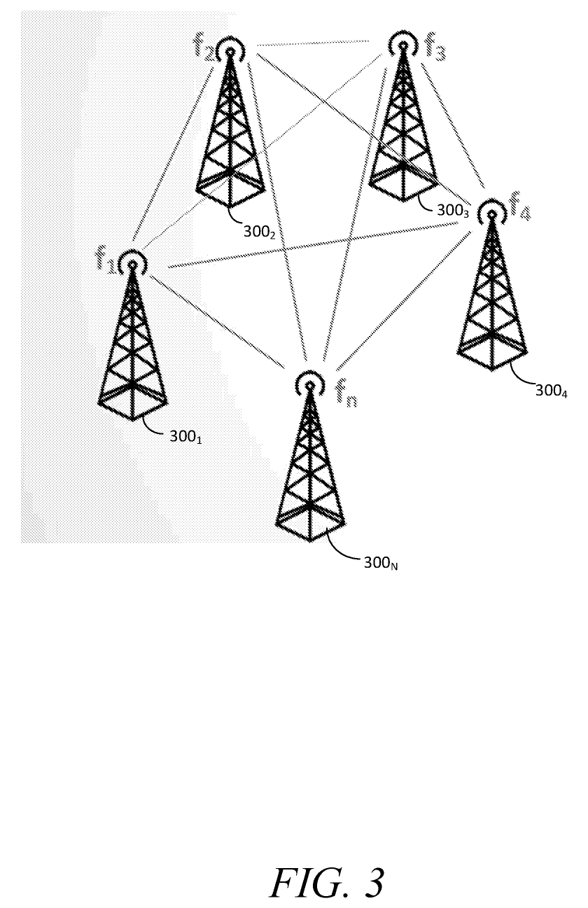

FIG. 3 is a schematic diagram illustrating BPS transmitters transmitting emission timing and location information to neighboring BPS transmitters;

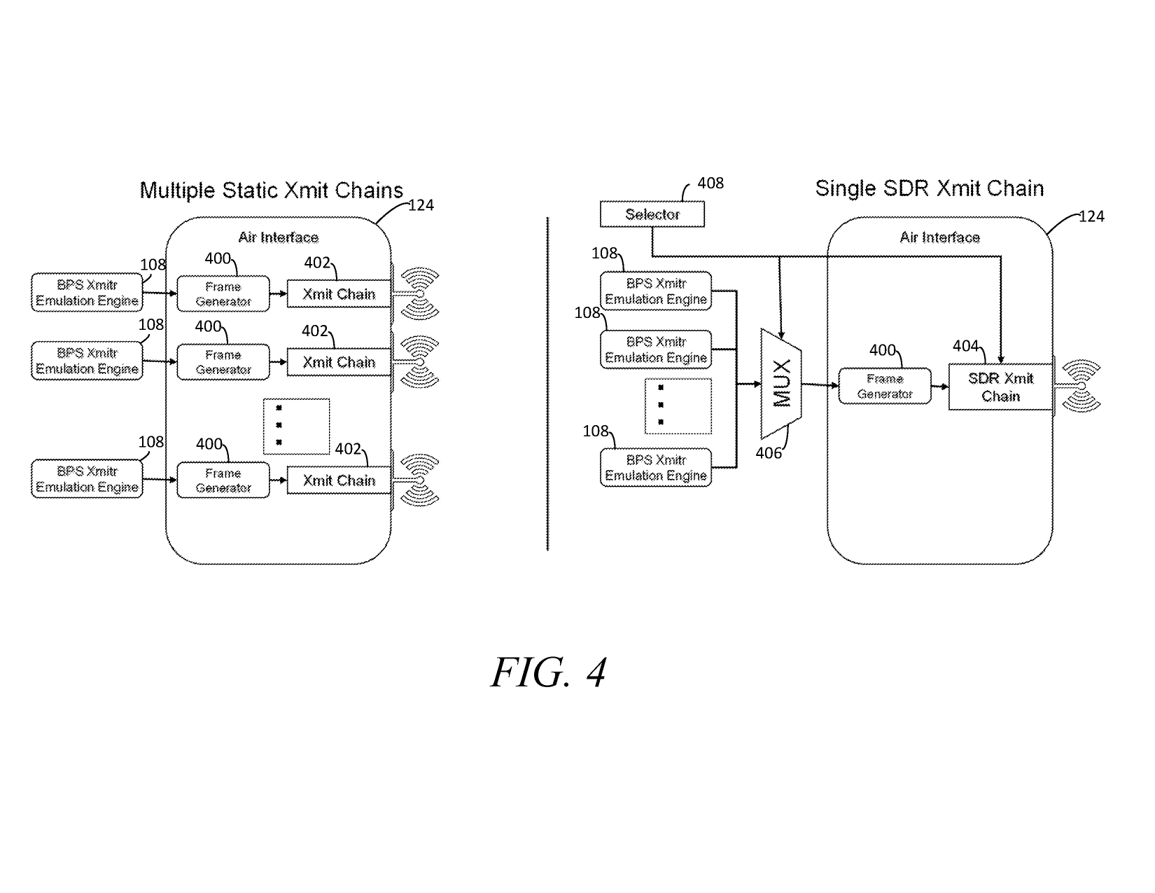

FIG. 4 is a block diagram illustrating examples of two different implementations of an air interface of a BPS test system;

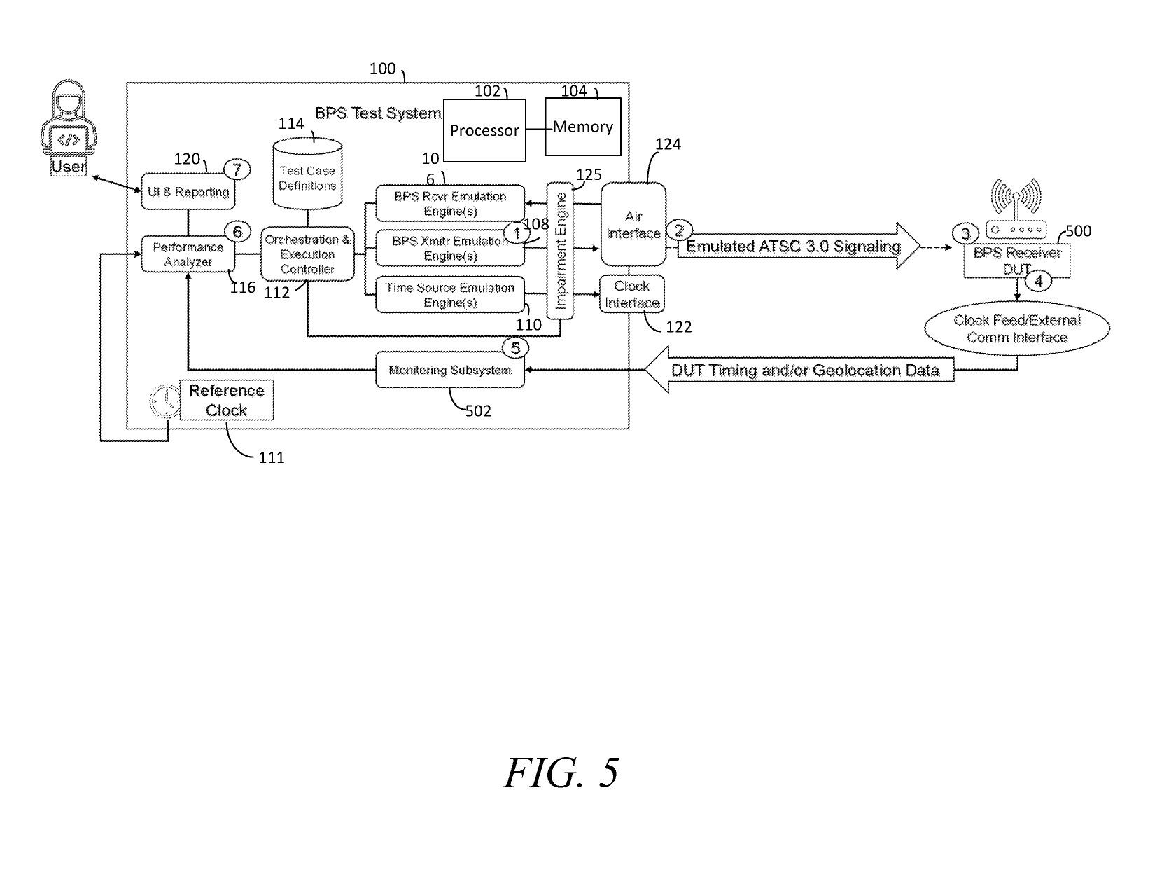

FIG. 5 is a block diagram of a BPS test system and a BPS receiver illustrating exemplary steps performed by the BPS test system in testing the BPS receiver;

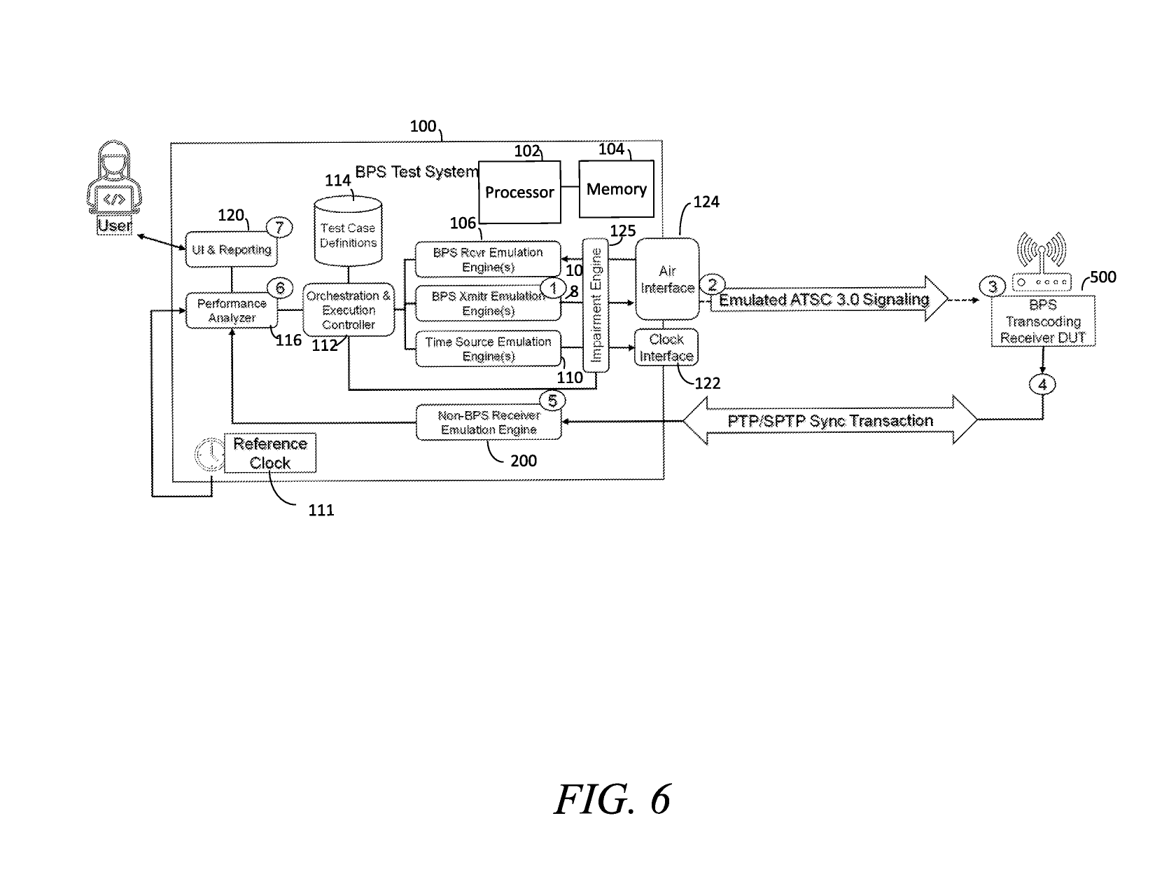

FIG. 6 is a block diagram of a BPS test system and a transcoding BPS receiver illustrating exemplary steps performed by the BPS test system in testing the transcoding BPS receiver; and

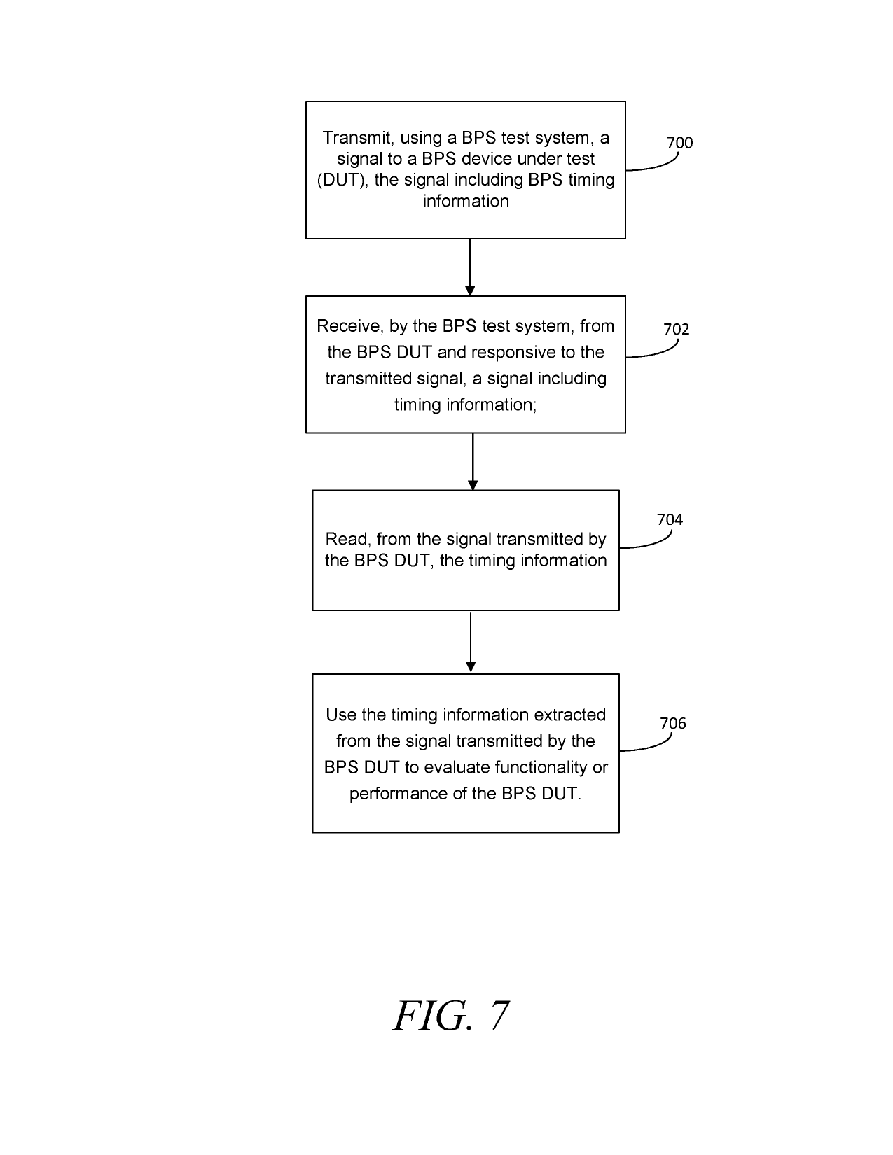

FIG. 7 is a flow chart illustrating an exemplary process for testing a BPS device under test.

### DETAILED DESCRIPTION

The subject matter described herein includes a BPS test system that tests various functional elements of a broadcast positioning system (BPS). BPS functional elements may include a BPS transmitter and a BPS receiver or client device. The BPS test system may include hardware and software components that emulate BPS network elements, such as BPS transmitters and BPS receivers. In some multi-channel modes of operation, a BPS network may include multiple BPS transmitters, with each BPS transmitter broadcasting on different frequency channels (e.g., BPS transmitters would transmit advanced television committee (ATSC) 3.0 signals, with each of the signals being transmitted on a different frequency channel, etc.). In one example, the test system may utilize a software defined radio (SDR) to emulate multiple BPS transmitters, with each emulated BPS transmitter broadcasting on a different frequency channel. For example, an air interface component of the test system may include one or more SDR transmitters/transmit chains, which are used by a BPS transmitter emulation engine(s) during execution of a test case involving a physical BPS transmitter DUT or BPS receiver terminal/client device DUT. By doing so, the test system may present to the DUT/SUT what appears to be a geo- diverse collection (or network) of BPS transmit stations/towers.

Each emulated BPS transmitter may be configured during execution of a test case to communicate differing geolocation coordinate information and/or time stamps via ATSC 3.0 signaling, thereby enabling the test system to dynamically emulate BPS environments with varying transmitter geo-topologies and/or time references.

In some examples, the BPS test system may emulate and source a reference time clock, whose timing information is used by a DUT/SUT. The BPS test system may obtain access to one or more time sources (e.g., GNSS, atomic clock, Precision Time Protocol/IEEE 1588, eLoran, other BPS transmitters, etc.) and may use any one of these (or all) during the execution of a test case or series of test cases. The BPS test system may use an external clock interface to provide this reference clock signal to the DUT/SUT.

Exemplary test case definitions used by the BPS test system may include geo-location coordinate information describing/defining the position of emulated BPS elements (e.g., emulated BPS transmitters, emulated BPS receiver terminals/client devices, etc.) and/or physical BPS DUT/SUT elements (e.g., real BPS transmitters, real BPS receiver terminals/client devices, etc.). Such geo- location coordinate/topology information may be used during the execution of a test case to compute timestamp information that is transmitted by each emulated BPS transmitter and to evaluate DUT/SUT performance results.

The BPS test system may generate and/or distribute multiple different reference clock signals (e.g., GNSS, atomic clock, Precision Time Protocol/IEEE 1588, eLoran, other BPS transmitters, etc.). The BPS test system may impair one or more of these reference clock signals and monitor/observe resulting the DUT/SUT behavior (e.g., receive, decode and analyze timing information broadcast by a BPS transmitter DUT, etc.).

The BPS test system may use multiple BPS transmitter emulators to emulate BPS signals and/or an SDR for broadcasting multiple BPS signals on different BPS frequency channels. These multiple BPS signals can have physical layer impairments applied by the BPS test system. The BPS test system may monitor the behavior of the DUT/SUT in response to these. The BPS test system may provide one or more reference clock signals to the DUT/SUT. The reference clock signals may have impairments applied by the BPSD test system. The test system may monitor the behavior of the DUT/SUT in response to these impairments. If, for example, the DUT is a BPS transmitter, the BPS test system may compare/analyze the BPS broadcast timestamp and a provided reference clock signal and compute and report a performance metric, such as a difference between the BPS timestamp broadcast by the BPS transmitter and a timestamp obtained from the reference clock signal.

If multiple reference clock signals are provided by the BPS test system, the BPS test system may monitor and report the switchover/failover performance of a BPS transmitter DUT in response to various test system-initiated reference clock impairments. The BPS test system may emulate one BPS transmitter (i.e., a high-fidelity emulation) within a simulated network of BPS transmitters. The BPS test system may generate timing and geo-location data for each of the remaining simulated BPS transmitters (i.e., low fidelity emulations) in the network and include this data in the ATSC 3.0 signal that is broadcast over the air interface by the "high fidelity" emulated BPS transmitter.

The BPS test system may manipulate the timing and geo-location data for each of the low fidelity simulated BPS transmitters in the network. The BPS test system may monitor and report the associated behavior of the DUT/SUT in response to these impairments. The BPS test system has the ability to access a DUT (e.g., BPS receiver terminal, etc.) local/recovered clock (e.g., via an external clock interface, etc.) and/or timing information (e.g., via PTP messaging, etc.), analyze this clock and/or timing information, and compute one or more associated performance metrics for the DUT. For example, the BPS test system may include a monitoring agent or probe installable on a BPS receiver terminal DUT, and the monitoring agent may be used to access and report local clock/timing information back to a performance analyzer associated with the BPS test system.

The BPS test system may have a monitoring use case implementation where elements of the BPS test system could be employed as a component of a performance-auditing or overlay deployment. Such an auditing system may receive the time signals from a plurality of actual BPS transmitter sites and serve as a means to assess the presence, validity, and accuracy of the transmitted time and/or geo-location signals. The timing and geo-location data for each of the BPS transmitters so monitored could be remotely or locally received from the perspective of any of the transmitter sites.

One example of such an audit overlay system may include elements that are ideally geographically positioned to be able to receive a plurality of BPS transmissions. The auditing subsystem may contain artificial intelligence/machine learning (AI/ML) tools such that a real time alteration of the integrity of one or more than one of the BPS signals being monitored for audit would trigger an alert to be used by the system operator. The auditing overlay system may include AI/ML tools such that an abbreviated but comprehensive record of the integrity of the transmitted signals would be available in an archive for forensic purposes. The auditing subsystem may employ blockchain techniques to ensure the integrity of any data recorded and made available forensic purposes.

Use Case 1: Reference Clock Testing In this use case, the BPS test system may execute tests that are intended to determine the conformance and/or performance characteristics of a BPS transmitter, such as a BPS ATSC 3.0-capable transmitter. Exemplary test cases may include, but are not limited to, tests that are intended to determine conformance/performance of a BPS transmitter DUT with respect to ingress reference clock signal(s) that are used by the DUT to generate ATSC 3.0 broadcast signals.

FIG. 1A is a block diagram illustrating an example architecture for a BPS test system capable of performing reference clock testing, BPS receiver emulation, BPS transmitter emulation, and time source emulation. Referring to FIG. 1A, a BPS test system 100 may include at least one processor 102 and a memory 104. BPS test system 100 may further include BPS receiver emulation engines 106 capable of emulating BPS receivers, BPS transmitter emulation engines 108 capable of emulating GPS transmitters, and time source emulation engines 110 capable of emulating time sources. A reference clock generator 111 may provide timing inputs to time source emulation engines 110.

BPS test system 100 may further include an orchestration and emulation controller 112 for controlling emulation engines 106, 108, and 110 to implement different tests of BPS devices under test, such as BPS transmitter DUT 113, based on test case definitions 114. BPS test system 100 further includes a performance analyzer 116 for analyzing BPS test results and storing the results in a results database 118. BPS test system 100 may further include a UI and reporting interface 120 that allows the user to configure and initiate tests and to receive results of execution of the test from performance analyzer 116. BPS test system 100 may further include a clock interface 122 for sending emulated reference clock signals to devices under test. BPS test system 100 may also include an air interface 124 for receiving ASTC 3.0 signaling from devices under test. BPS test system 100 may further include an impairment engine 125 for adding emulated impairments to transmitted and received BPS and non-BPS signals.

In the test scenario illustrated in FIG. 1A, in step 1, test system 100 provides one or more reference clock/timing signals to DUT 113, e.g., via a physical link, a wireless link, etc.). In step 2, BPS transmitter DUT 113 receives the ingress reference clock signal(s). In step 3, BPS transmitter DUT 113 uses the ingress reference clock/timing signal(s) to generate an ATSC 3.0 signal that includes timing information in ATSC 3.0 format. FIG. 1 B illustrates an example of parameters that may be included in an ATSC 3.0 signal. The ATSC 3.0 signal includes a preamble that includes L1D timing information. The L1D timing information is based on a reference clock received by BPS transmitter DUT 113 in this example, the reference clock is the reference clock provided by BPS test system 100.

Returning to FIG. 1A, in step 4, the ATSC 3.0 signal is broadcast via the DUT's transmit antenna. In some use cases where multiple ingress reference clock signals are provided to the DUT, the DUT is expected to select and utilize the best available reference clock signal. BPS test system 100 may apply impairments to some or all of the reference clock/timing signals that are provided to the DUT. In step 5, the broadcast ATSC 3.0 signal is received by a BPS receiver emulation engine 106. In step 6, the received ATSC 3.0 signal is analyzed, and the observed DUT behavior/performance (e.g., which reference time source signal is selected, when does the selection occur, how does the broadcast time information compare to the reference time clock, etc.). To determine this information, performance analyzer 116 may read the L1D time information from the ATSC 3.0 signal preamble illustrated in FIG. 1 B, compute timestamps using the one or more reference times transmitted by BPS test system 100 to DUT 113 and compare the locally computed timestamps to the L1 D timing information. In one example test, BPS receiver emulation engine 106 may transmit a single reference clock to DUT 113, and performance analyzer 116 may determine whether the locally computed timestamp matches the received L1 D timing information.

In this use case, BPS test system 100 may execute tests that are intended to determine the conformance and/or performance characteristics of a BPS transmitter, such as a BPS ATSC 3.0-capable transmitter. In step 7, one or more conformance/performance metrics may be generated and reported. Continuing with the timestamp comparison test described above, if the locally computed timestamp matches the received L1D timing information, BPS test system 100 may determine that DUT 113 passed the test.

Thus, in one example, a BPS test system is configured to test a BPS transmitter DUT for conformance with ATSC 3.0 timing. To implement such a test, BPS test system 100 may utilize reference clock signal generator 111 and time source emulation engine 110 to generate and send a reference clock signal to BPS transmitter DUT 113. The reference clock signal may include one or more impairments applied prior to transmission to DUT 113. BPS receiver emulation engine 106 may receive a BPS broadcast signal (e.g., an ATSC 3.0 signal) from DUT 113 and extract BPS timing information from the BPS signal. Performance analyzer 116 may compare the received BPS timing information with the reference clock signal and/or a timestamp generated from the reference clock signal and compute and report one or more DUT performance metrics. For example, performance analyzer 116 may report a difference between the received timing information and the value of the reference clock communicated to DUT 113, a difference between the locally computed timestamp and the received timing information, or other suitable timing-related performance metric.

### Use Case 2: BPS Transcoder and ATSC 3.0 Timing Relay Testing

In a transcoding use case, BPS test system 100 may execute tests that are intended to determine the conformance and/or performance characteristics of a BPS transcoder, such as a BPS ATSC 3.0-capable receiver which extracts the encoded timestamp and/or geolocation data for use as a source of such information to be re-sent via a mechanism other than ATSC 3.0. In a non- transcoding relay use case, BPS test system 100 may transmit one or more emulated ATSC 3.0 signals to a BPS transmitter under test, receive an ATSC 3.0 signal transmitted by the BPS transmitter under test and determine whether the ATSC 3.0 receiver relayed the correct ATCS 3.0 timing information. The non- transcoding relay use case is illustrated in FIG. 2A. The transcoding relay use case is illustrated in FIG. 2B.

One test case may include a test that determines conformance/performance of a BPS receiver DUT with respect to deployment scenarios where multiple BPS receivers assess and potentially rank or otherwise filter location and timing information, as generally illustrated in FIG. 3. In FIG. 3, each BPS transmitter 3001-300N transmits signal emission timing and location information to neighboring BPS transmitters. Each BPS transmitter 3001-300N may utilize the emission timing and location information received from the neighboring BPS transmitters to detect timestamping errors by neighboring transmitters. For example, BPS transmitter 3001 may receive emission timing information from neighboring transmitters 3002-300N, determine, from the emission timing information, a reference clock signal, and use the reference clock signal to detect when one of BPS transmitters 3002-300N reports incorrect timing information in a transmitted frame. To test the functionality illustrated in FIG. 3, BPS test system 100 may replace any of transmitters 300r300N and utilize this process to determine whether any of the neighboring transmitters is making timestamping errors in its transmissions.

Returning to the non-transcoding timing information relay case illustrated in FIG. 2A, in step 1, BPS transmitter emulation engine 108 generates geo- location and timing information for one or more BPS transmitters in a BPS network environment. In step 2, BPS transmitter emulation engine 108 constructs a single ATSC 3.0 signal that includes the geo-location and timing information for all of the multiple BPS transmitters and broadcasts this signal towards BPS transmitter DUT 113. In an alternate example, multiple BPS transmitter emulation engines 108 may construct multiple ATSC 3.0 signals, where each signal includes geo-location and timing information for some or all of the multiple BPS transmitters and broadcast these signals towards BPS transmitter DUT 113.

The broadcasting of these multiple signals may be accomplished using multiple transmit chains/antennas or using a single transmit chain/antenna in conjunction with a software defined radio (SDR), as generally illustrated in FIG. 4. Each emulated BPS signal can be individually impaired at the physical layer and/or the ATSC 3.0 signal preamble, and bootstrap and payload contents may be modified/impaired. In one example illustrated in FIG. 4, air interface 124 includes parallel frame generators 400 and transmit chains 402 that feed the transmitter antennas. In the other example illustrated in FIG. 4, air interface 124 includes a single frame generator 400 followed by a transmit chain implemented using a software defined radio 404. A multiplexer 406 whose output is controlled by a selector 408 multiplexes signals from BPS transmitter emulation engines 108. In one example, multiplexer 406 multiplexes M input signals to produce N output signals, where N and M are integers, and M is greater than N.

Returning to FIG. 2A, in step 3, BPS transmitter DUT 113 receives the BPS signal(s). In step 4, BPS transmitter DUT 113 extracts BPS timing information from the ATSC 3.0 signal(s) and generates and broadcasts an ATSC 3.0 signal that includes the received BPS timing information.

In step 5, BPS receiver emulation engine 106 receives the relayed ATSC 3.0 signal and extracts the ATSC 3.0 timing information. In step 6, performance analyzer 116 compares the relayed timing information to the transmitted ATSC 3.0 timing information and determines whether the information matches. If the timing information matches, in step 7, performance analyzer 116 may report that the DUT passed the BPS timing relay test. If the timing information does not match, performance analyzer 116 may report that the device under test failed the BPS timing relay test.

FIG. 2B illustrates exemplary steps performed by BPS test system 100 in testing a transcoding BPS transmitter DUT. In FIG. 2B, it is assumed that BPS transmitter DUT 113 is capable of receiving and extracting timing information in an ATSC 3.0 signal, converting the timing information into a non- ATSC 3.0 format, such as a precision time protocol (PTP) format, and communicating the transcoding timing information to a non-ATSC 3.0 receiver.

Referring to FIG. 2B, in step 1, BPS transmitter emulation engine 108 generates geo-location and timing information for one or more BPS transmitters in a BPS network environment. In step 2, BPS transmitter emulation engine 108 constructs a single ATSC 3.0 signal that includes the geo-location and timing information for all of the multiple BPS transmitters and broadcasts this signal towards the BPS transmitter DUT 113. In step 3, BPS transmitter DUT 113 receives the BPS signal(s). In step 4, BPS transmitter DUT 113 extracts BPS timing information from the ATSC 3.0 signal(s), transcodes the BPS timing information into a non-ATSC 3.0 format, such as PTP format, and transmits the transcoded timing information to BPS test system 100. The transmission may occur over a wired or a wireless link. If the information being transmitted is PTP timing information, the information may be transmitted over an IP network, such as the Internet.

In step 5, a non-ATSC 3.0 receiver, such as non-ATSC 3.0 receiver emulation engine 200 receives the signal with the non-ATSC 3.0 timing information, extracts the timing information, and provides the timing information to performance analyzer 116. Non-ATSC 3.0 receiver emulation engine 200 may also observe/monitor the DUT's clock signal (e.g., via an external clock feed that is cabled between the test system and the DUT). In step 6, performance analyzer 116 may compare the received timing information to the transmitted timing information, for example, to determine whether the timing information matches.

In step 7, performance analyzer 116 may provide a report of results of the test via UI 120. The results may indicate whether or not DUT 113 passed the test and may indicate the difference between the transmitted and received timing information.

Thus, in one example, the subject matter described herein includes a BPS test system for testing and evaluating the transcoding and non-transcoding timing relay functionality of a BPS transmitter. The BPS test system may include a BPS transmitter emulation engine for broadcasting a BPS signal including BPS- formatted timing information. The BPS test system may further include a receiver emulation engine for using the reference clock signal to generate emulated BPS timing information for one or more BPS transmitters and for including the emulated timing information in one or more BPS frames broadcast towards a transcoding BPS transmitter. The BPS test system may include a BPS receiver emulation engine for receiving a signal from the BPS transmitter under test and decoding from the signal. For the non-transcoding timing relay case, the BPS receiver emulation engine may be a BPS receiver, such as an ATSC 3.0 receiver. For the transcoding relay case, the BPS receiver emulation engine may be a non-BPS receiver, such as a PTP receiver. The BPS test system may also include a performance analyzer for comparing the transmitted and received timing information and generating a performance analysis result.

### Use Case 3: BPS Receiver Testing

In this use case, BPS test system 100 executes tests that are intended to determine the conformance and/or performance characteristics of a BPS receiver, such as a BPS ATSC 3.0-capable receiver. Exemplary test cases may include, but are not limited to, tests that are intended to determine conformance/performance of a BPS receiver DUT.

FIG. 5 illustrates an example of using BPS test system 100 to test a BPS receiver. Referring to FIG. 5, in step 1, BPS transmitter emulation engine 108 generates geo-location and timing information for one or more BPS transmitters in a BPS network environment. In step 2, BPS transmitter emulation engine transmits an emulated ATSC 3.0 signal, including the geo-location and timing information, to a BPS receiver under test 500. In one example, a single BPS transmitter emulation engine 108 constructs a single ATSC 3.0 signal that includes the geo-location and timing information for the one or more BPS transmitters and broadcasts this signal towards BPS receiver DUT 500.

In another example, multiple BPS transmitter emulation engines 108 construct multiple ATSC 3.0 signals, where each signal includes geo-location and timing information for the one or more BPS transmitters and broadcast these signals towards BPS receiver DUT 500. Broadcasting of these multiple signals may be accomplished using multiple transmit chains/antennas or using a single transmit chain/antenna in conjunction with an SDR as generally illustrated in FIG. 4.

Each BPS signal can be individually impaired at the physical layer and/or the ATSC 3.0 signal preamble, and bootstrap and payload contents may be modified/impaired.

Returning to FIG. 5, in step 3, BPS receiver DUT 500 receives and processes the received emulated ATSC 3.0 signal. In step 4, BPS receiver DUT 500 processes the geo-location and timing information extracted from the ATSC 3.0 signal(s) and uses this information to synchronize its internal clock. The receiver DUT's internal clock signal/information is tapped/probed or otherwise made available to BPS test system 100. In step 5, a clock monitoring subsystem 502 of BPS test system 100 receives the DUT's clock/timing information. In step 6, performance analyzer 116 may analyze the performance of BPS receiver DUT 500 by comparing the received timing information with the timing information indicated by a reference clock (e.g., a reference clock provided by an external clock feed that is cabled between the test system and the DUT). In step 7, performance analyzer 116 provides the analysis results to the user via UI 120.

Thus, in one example, a BPS test system may include a reference clock signal generator for providing a reference clock signal. The BPS test system may further include one or more transmitter emulation engine(s) for using the reference clock signal to generate emulated BPS timing information for one or more BPS transmitters, and for including this timing information in one or more BPS frames that are broadcast towards a BPS receiver DUT. The BPS test system may include a clock monitoring subsystem receiving BPS-derived timing information from the BPS receiver DUT. The BPS test system may include a performance analyzer for comparing the received BPS-derived timing information with the reference clock signal and computing and reporting one or more DUT performance metrics, such as the difference between timing information received from the BPS receive DUT and the reference timing information.

### Use Case 4: BPS Transcoding Receiver Testing

In this use case, BPS test system 100 may execute tests to determine the conformance and/or performance characteristics of a BPS transcoder, such as a BPS ATSC 3.0-capable transcoding receiver that receives a BPS ATSC 3.0 signal, extracts timing information from the received signal and distributes the timing information to one or more client devices (e.g., servers, compute nodes, etc.), for example, using PTP or SPTP. FIG. 6 illustrates the use of BPS test system 100 to test a BPS transcoding receiver. Referring to FIG. 6, in step 1, BPS transmitter emulation engine 108 generates geo-location and timing information for one or more emulated BPS transmitters. In step 2, BPS transmitter emulation engine 108 transmits the emulated geo-location and timing information to BPS transcoding receiver DUT 500. In one example, a single BPS transmitter emulation engine 108 constructs a single ATSC 3.0 signal that includes the geo-location and timing information for one or more emulated BPS transmitters and broadcasts this signal towards the BPS transcoding receiver DUT 500. In another example, multiple BPS transmitter emulation engines 108 may construct multiple ATSC 3.0 signals, where each signal includes geo- location and timing information for the one or more emulated BPS transmitters and broadcasts these signals towards BPS transcoding receiver DUT 500.

Broadcasting of these multiple signals may be accomplished using multiple transmit chains/antennas or using a single transmit chain/antenna in conjunction with an SDR, as illustrated in FIG. 4. Each BPS signal can be individually impaired at the physical layer and/or the ATSC 3.0 signal preamble, and bootstrap and payload contents may be modified/impaired.

Returning to FIG. 6, in step 3, BPS transcoding receiver DUT 500 receives and processes the BPS signal(s). In step 4, BPS transcoding receiver DUT 500 processes the geo-location and timing information extracted from the ATSC 3.0 signal(s) and uses this information to synchronize its internal clock. In this example, BPS transcoding receiver DUT 500 may function as a grandmaster clock and use the received BPS timing information to engage in a PTP/SPTP synchronization transaction with a remote timing client/slave clock that is emulated by BPS test system 100. In step 5, non-BPS receiver emulation engine 200 may emulate a timing client, such as a PTP client or slave device, by receiving the DUT's clock/timing information. In step 6, performance analyzer 116 analyzes the DUT's clock signal/timing information (provided via the PTP/SPTP signaling).

In step 7, performance analyzer 116 generates, based on the analysis one or more conformance/ performance metrics and communicates the performance metrics to the user via UI 120.

Thus, a BPS test system for testing a BPS transcoding receiver DUT may include a BPS transmitter emulation engine for generating and transmitting a BPS signal including timing information to a BPS transcoding receiver DUT. The BPS test system may further include a non-BPS receiver emulation engine that emulates a timing synchronization client for engaging in a time synchronization transaction (e.g., PTP, SPTP, etc.) with the BPS transcoding receiver DUT. The BPS test system may further include a performance analyzer that compares results of the time synchronization transaction with a reference clock signal and computes and reports one or more DUT performance metrics.

FIG. 7 is a flow chart illustrating an exemplary process for testing a BPS device. Referring to FIG. 7, in step 700, the process includes transmitting, using a BPS test system, a signal to a BPS device under test (DUT), the signal including BPS timing information. For example, a BPS test system, such as BPS test system 100, may send an ATSC 3.0 signal or a reference clock signal including timing information to a BPS transmitter or a BPS receiver under test.

In step 702, the process further includes receiving, by the BPS test system, from the BPS DUT and responsive to the transmitted signal, a signal including timing information. For example, a BPS test system, such as BPS test system 100, may receive an ATSC 3.0 signal or a non-ATSC signal that includes timing information provided by the BPS transmitter or receiver under test.

In step 704, the process further includes reading, from the signal transmitted by the BPS DUT, the timing information. For example, a BPS test system, such as BPS test system 100, may read the timing information from the ATSC or the non-ATSC signal.

In step 706, the process further includes using the timing information read from the signal transmitted by the BPS DUT to evaluate functionality or performance of the BPS DUT. For example, a BPS test system, such as BPS test system 100, may compare the received timing information to the transmitted timing information or a local reference clock to evaluate the performance and/or functionality of the BPS transmitter or receiver under test.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for testing a broadcast positioning system (BPS) device, the method comprising:transmitting, using a BPS test system, a signal to a BPS device under test (DUT), the signal including BPS timing information, wherein transmitting the signal to the BPS DUT includes transmitting an advanced television systems committee (ATSC) signal to a BPS DUT configured to operate as an ATSC timing relay or an ATSC timing transcoder;receiving, by the BPS test system, from the BPS DUT and responsive to the transmitted signal, a signal including timing information;reading, from the signal transmitted by the BPS DUT, the timing information; andusing the timing information extracted from the signal transmitted by the BPS DUT to evaluate functionality or performance of the BPS DUT.

2. The method of claim 1 wherein: transmitting the ATSC signal to the BPS DUT configured to operate as the ATSC timing relay or the ATSC timing transcoder includes transmitting the ATSC signal to a BPS transmitter DUT configured to operate as the ATSC timing relay; receiving the signal from the BPS transmitter DUT configured to operate as the ATSC timing relay includes receiving an ATSC signal from the BPS transmitter DUT configured to operate as the ATSC timing relay; and using the timing information to evaluate functionality or performance of the BPS DUT includes comparing the timing information extracted from the ATSC signal transmitted by the BPS transmitter DUT configured to operate as the BPS timing relay to the timing information in the ATSC signal transmitted to the BPS transmitter DUT configured to operate as the ATSC timing relay.

3. The method of claim 1 wherein: transmitting the ATSC signal to the BPS DUT configured to operate as the ATSC timing relay or the ATSC timing transcoder includes transmitting the ATSC signal to a BPS transmitter DUT configured to operate as the ATSC timing transcoder; receiving the signal from the BPS transmitter DUT configured to operate as the ATSC timing transcoder includes receiving a non-ATSC signal from the BPS transmitter DUT configured to operate as the ATSC timing transcoder; and using the timing information to evaluate functionality or performance of the BPS DUT includes comparing the timing information extracted from the non-ATSC signal transmitted by the BPS transmitter DUT configured to operate as the ATSC timing transcoder to the timing information in the ATSC signal transmitted to the BPS transmitter DUT configured to operate as the ATSC timing transcoder.

4. The method of claim 3 wherein receiving the non-ATSC signal includes receiving a precision time protocol (PTP) signal.

5. The method of claim 1 wherein transmitting the signal to the BPS DUT includes transmitting a plurality of signals to the BPS DUT using a plurality of parallel combinations of frame generators and transmit signal chains.

6. The method of claim 1 wherein transmitting the signal to the BPS DUT includes transmitting N output signals to the BPS DUT using a multiplexer that multiplexes M signals to produce the N output signals for transmission to the BPS DUT via a transmit signal chain implemented by a software defined radio (SDR), wherein M and N are integers and M is greater than N.

7. A method for testing a broadcast positioning system (BPS) device, the method comprising:transmitting, using a BPS test system, a signal to a BPS receiver device under test (DUT);
receiving, by the BPS test system, from the BPS receiver DUT and responsive to the transmitted signal, a signal including timing information;reading, from the signal transmitted by the BPS receiver DUT, the timing information; andusing the timing information extracted from the signal transmitted by the BPS receiver DUT to evaluate functionality or performance of the BPS receiver DUT.

8. The method of claim 7 wherein: transmitting the signal to the BPS receiver DUT includes transmitting a reference clock signal to the BPS receiver DUT; receiving the signal from the BPS receiver DUT includes receiving an advanced television systems committee (ATSC) signal from the BPS receiver DUT; and using the timing information to evaluate functionality or performance of the BPS receiver DUT includes comparing the timing information extracted from the signal transmitted by the BPS receiver DUT to the reference clock signal.

9. The method of claim 7 wherein: transmitting the signal to the BPS receiver DUT includes transmitting an advanced television systems committee (ATSC) signal to the BPS receiver DUT configured to operate as an ATSC timing transcoder and a timing information source; receiving the signal from the BPS receiver DUT configured to operate as the ATSC timing transcoder and the timing information source includes receiving a non-ATSC signal from the BPS receiver configured to operate as the ATSC timing transcoder and the timing information source; and using the timing information to evaluate functionality or performance of the BPS receiver DUT includes comparing the timing information extracted from the non-ATSC signal transmitted by the BPS
transmitter DUT configured to operate as the ATSC timing transcoder and the timing information source to a reference clock.

10. The method of claim 9 wherein the BPS receiver DUT configured to operate as the ATSC timing transcoder, and the timing information source includes a BPS receiver configured to operate as an ATSC-to-precision time protocol (PTP) timing transcoder and PTP grandmaster.

11. A system for testing a broadcast positioning system (BPS) device, the system comprising:a BPS test system including at least one processor and a memory;at least one emulator implemented by the at least one processor for transmitting, using a BPS test system, a signal to a BPS device under test (DUT), the signal including BPS timing information, receiving, by the BPS test system, from the BPS DUT and responsive to the transmitted signal, a signal including timing information, reading, from the signal transmitted by the BPS DUT, the timing information, wherein transmitting the signal to the BPS DUT includes transmitting an advanced television systems committee (ATSC) signal to a BPS DUT configured to operate as an ATSC timing relay or an ATSC timing transcoder; anda performance analyzer implemented by the at least one processor for using the timing information extracted from the signal transmitted by the BPS DUT to evaluate functionality or performance of the BPS DUT.

12. The system of claim 11 wherein: the BPS DUT comprises a BPS transmitter DUT configured to operate as the ATSC timing relay; the signal received from the BPS DUT comprises an ATSC signal from the BPS transmitter DUT configured to operate as the ATSC timing relay; and the performance analyzer is configured to use the timing information to evaluate functionality or performance of the BPS DUT by comparing the timing information read from the ATSC signal transmitted
by the BPS transmitter DUT configured to operate as the BPS timing relay to the timing information in the ATSC signal transmitted to the BPS transmitter DUT configured to operate as the ATSC timing relay.

13. The system of claim 11 wherein: the BPS DUT comprises a BPS transmitter DUT configured to operate as the ATSC timing transcoder; the signal received from the BPS transmitter DUT configured to operate as the ATSC timing transcoder comprises a non-ATSC signal; and the performance analyzer is configured to use the timing information to evaluate functionality or performance of the BPS DUT by comparing the timing information read from the non-ATSC signal transmitted by the BPS transmitter DUT configured to operate as the ATSC timing transcoder to the timing information in the ATSC signal transmitted to the BPS transmitter DUT configured to operate as the ATSC timing transcoder.

14. The system of claim 13 wherein the non-ATSC signal comprises a precision time protocol (PTP) signal.

15. The system of claim 11 comprising a plurality of parallel combinations of frame generators and transmit signal chains for transmitting a plurality of signals to the BPS DUT.

16. The system of claim 11 comprising: a multiplexer configured to multiplex M signals to produce N output signals for transmission to the BPS DUT, where M and N are integers and M is greater than N; and a transmit signal chain implemented by a software defined radio (SDR) for receiving the N output signals and transmitting the N output signals to the BPS DUT.

17. A BPS test system comprising:at least one processor and a memory;
at least one emulator implemented by the at least one processor for transmitting, using a BPS test system, a signal to a BPS receiver device under test (DUT), the signal including BPS timing information, receiving, by the BPS test system, from the BPS receiver DUT and responsive to the transmitted signal, a signal including timing information, reading, from the signal transmitted by the BPS receiver DUT, the timing information; anda performance analyzer implemented by the at least one processor for using the timing information extracted from the signal transmitted by the BPS DUT to evaluate functionality or performance of the BPS DUT.

18. The system of claim 17 wherein: the signal transmitted to the BPS receiver DUT comprises a reference clock signal; the signal from the BPS receiver DUT comprises an advanced television systems committee (ATSC) signal; and the performance analyzer is configured to use the timing information to evaluate functionality or performance of the BPS receiver DUT by comparing the timing information extracted from the signal transmitted by the BPS receiver DUT to the reference clock signal.

19. The system of claim 17 wherein: the signal transmitted to the BPS receiver DUT includes an advanced television systems committee (ATSC) signal; the BPS receiver DUT is configured to operate as an ATSC timing transcoder and a timing information source; the signal received from the BPS receiver DUT configured to operate as the ATSC timing transcoder and the timing information source comprises a non-ATSC signal; and the performance analyzer is configured to use the timing information to evaluate functionality or performance of the BPS receiver DUT by comparing the timing information extracted from the non-ATSC signal transmitted by the BPS transmitter DUT configured to operate as
the ATSC timing transcoder and the timing information source to a reference clock.

20. A non-transitory computer readable medium having stored thereon executable instructions that when executed by a processor of a computer control the computer to perform steps comprising:transmitting, using a broadcast positioning system (BPS) test system, a signal to a BPS device under test (DUT), the signal including BPS timing information, wherein transmitting the signal to the BPS DUT includes transmitting an advanced television systems committee (ATSC) signal to a BPS DUT configured to operate as an ATSC timing relay or an ATSC timing transcoder;receiving, by the BPS test system, from the BPS DUT and responsive to the transmitted signal, a signal including timing information;reading, from the signal transmitted by the BPS DUT, the timing information; andusing the timing information extracted from the signal transmitted by the BPS DUT to evaluate functionality or performance of the BPS DUT.
